(19) United States
(12) Patent Application Publication
(10) Pub. No.: US 2013/0137413 A1
(43) Pub. Date: May 30, 2013

(54) Method and Apparatus for Controlling Device Operating Mode

(71) Applicant: Rajesh JAYACHANDRAN, Bangalore (IN)

(72) Inventor: Rajesh JAYACHANDRAN, Bangalore (IN)

(73) Assignee: NOKIA CORPORATION, Espoo (FI)

(21) Appl. No.: 13/368,072

(22) Filed: Feb. 7, 2012

(30) Foreign Application Priority Data
Feb. 7, 2011 (IN) 354/CHE/2011

(51) Int. Cl. H04W 8/22

(52) U.S. Cl. CPC H04W 8/22
USPC 455/418

(57) ABSTRACT

In a non-limiting and example embodiment, a method is provided for remotely managing operating modes of a mobile communications device, comprising: detecting an operating mode change command received by a mobile communications device in a message from a wireless access device, and changing an operating mode of the mobile communications device in response to the operating mode change command, the operating mode change affecting user interface output of the mobile communications device.

### RELATED APPLICATIONS

This application claims priority benefit to Indian Patent Application Number 354/CHE/2011, filed Feb. 7, 2011, which is herein incorporated by reference in its entirety.

### FIELD

The present invention relates to controlling operating mode of mobile communications devices.

### BACKGROUND

Users typically carry their mobile phones with them everywhere they go. In some situations the use of standard settings of the mobile phone is not suitable, for example ringing tones should be avoided during concerts or meetings. There are applications for mobile devices enabling a user to specify calendar events during which the device automatically disables sounds.

### SUMMARY

Various aspects of examples of the invention are set out in the claims.

According to a first embodiment, there is provided a method, comprising: detecting an operating mode change command received by a mobile communications device in a message from a wireless access device, and changing an operating mode of the mobile communications device in response to the operating mode change command, the operating mode change affecting user interface output of the mobile communications device.

According to a second embodiment, there is provided an apparatus comprising at least one processor and at least one memory including computer program code, the at least one memory and the computer program code being configured to, with the at least one processor, cause the apparatus at least to: detect an operating mode change command received in a message from a wireless access device, and change an operating mode in response to the operating mode change command, the operating mode change affecting user interface output.

The invention and various embodiments of the invention provide several advantages, which will become apparent from the detailed description below.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example of a wireless communications system;

FIG. 2 illustrates a method according to an embodiment;

FIG. 3 illustrates functional modules for an apparatus according to an embodiment;

FIG. 4 illustrates operating mode information records according an embodiment;

FIGS. 5 and 6 illustrate methods according to some embodiments;

FIG. 7 illustrates a service set identification information element; and

FIG. 8 illustrates a mobile communications device according to an embodiment.

### DETAILED DESCRIPTION

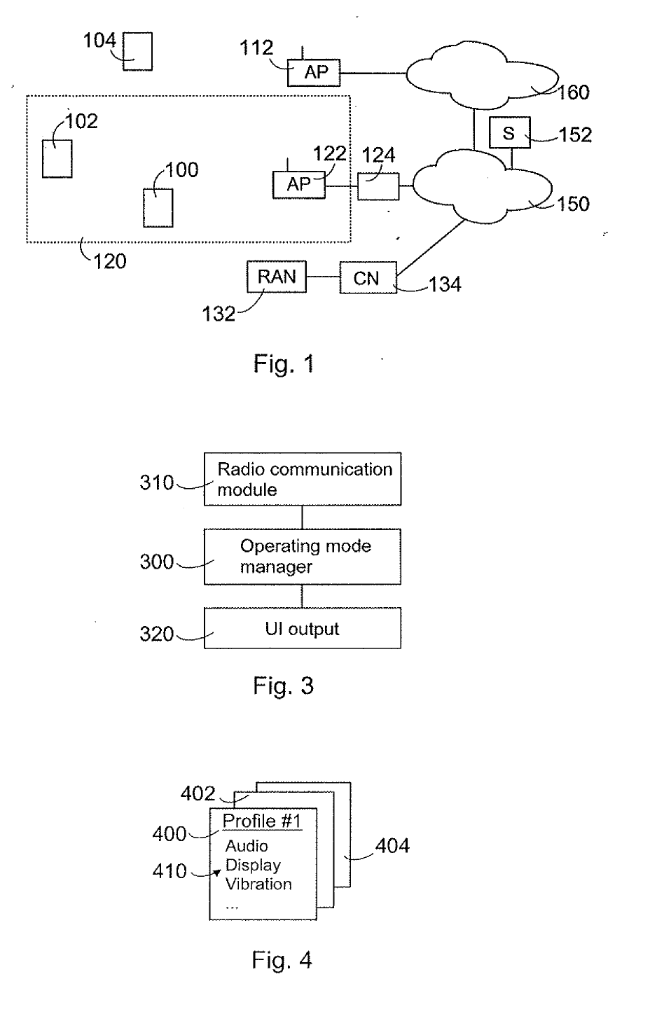

With reference to the example of FIG. 1, a mobile communications device 100, 102, 104, hereafter referred to as mobile device, may be able to connect a plurality of networks in a given geographical area.

Wireless local area network (WLAN) connectivity may be provided by a WLAN access point (AP) 122 such that mobile devices 100, 102 within an area 120 are able to connect the AP 122. The mobile device 100 may be arranged to periodically scan for available access points. The mobile device may be arranged to automatically connect a WLAN AP 122 when approaching or entering the area 120, such as an office.

There may also be other WLANs or other types of access networks available in the neighborhood. For example, another WLAN AP 112 may have a coverage range at least partly overlapping with the coverage area of the AP 122 and the area 120.

A cellular network comprising a radio access network (RAN) 132 and a core network (CN) 134 is typically available for the mobile device 100. The cellular network may be a network standardized by the Third Generation Partnership Project (3GPP) or the Third Generation Partnership Project Two (3GPP2), for instance.

The access network devices may provide connectivity to further services and/or networks 150, 160, such as a wide area network 150, which may be the Internet or part thereof. A server 152 may be connected to the wide area network 150 and may host an IP based service, such as a web service.

Instead of a network architecture comprising a plurality of network elements, a communications device, available as a wireless access device for the mobile device 100, may be even a single radio device connected to a further communications device. Also a mobile communications device, such as a mobile node capable of providing ad-hoc connections, may be visible for the mobile device 100 as an available wireless access device. There may also be short-range wireless access devices, such as Bluetooth devices or other wireless personal area network devices, available e.g. in the area 120.

However, it will be appreciated that these are only some examples of wireless access devices and access network types which a mobile device may be able to connect, and one or more further networks may be available. The application of the present operating mode change related features is not limited to any particular network configuration or network protocol.

The area 120 may represent a space, such as a meeting room or concert hall, in which the standard use of electronic devices is not allowed or appropriate. A mobile device may be provided with an application automatically switching the settings of the mobile phone in accordance with the current location or time. However, such applications require that the user has earlier set this location or time as requiring specific settings.

According to some embodiments of the present invention, a specific operating mode change command may be wirelessly sent by a wireless access device to mobile devices in an area. For example, such mode change command may be sent by a WLAN AP 122 to silence mobile devices 100, 102 entering the area 120. The AP 122 signal strength and/or antenna alignment may be adjusted so that the coverage area of the AP is close to the area 120.

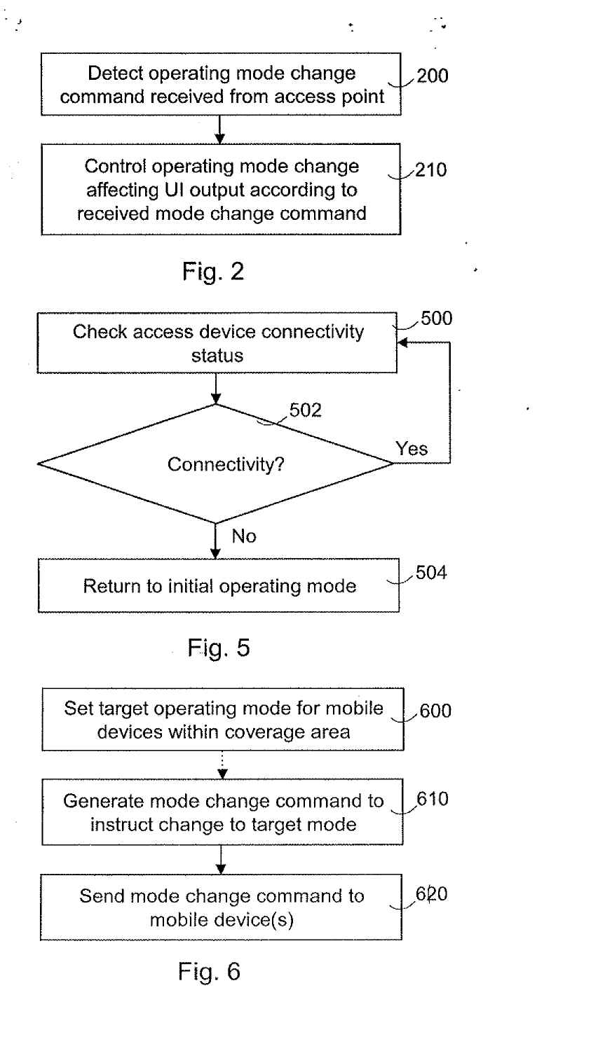

FIG. 2 illustrates a method according to an embodiment. The method of FIG. 2 may be applied in an apparatus the operating mode use of which is being managed, for example the mobile device 100.

An operating mode change command received by a mobile communications device in a message from a wireless access device is detected 200. A wireless access device may be any type of node providing wireless connectivity for the mobile communications device, for example a WLAN access point 122. An operating mode of the mobile communications device is changed 210 in accordance with the mode change command, the operating mode change affecting user interface output of the mobile communications device.

The term “operating mode” is to be understood broadly to refer to any type of mode, the change of which affects user interface (UI) output in some manner. Such operation modes typically comprise or affect a set of parameters or settings controlling UI output, typically at least audio outputs of notifications, such as notifications of incoming calls or messages. The operation modes are in some embodiments predefined profiles, each comprising a set of UI output settings. However, the operating mode may also refer to a single parameter or function, such as a parameter specifying sound on/off. The operation modes are typically customizable by the user.

It is thus possible to remotely and in a centralized manner change the applied operating mode of mobile communications devices in an area. The change of the operating mode may be arranged such that no input is required from users of the mobile devices.

FIG. 3 depicts illustrative functional entities related to managing operating modes in response to external signals for an apparatus, such as the mobile device 100. An operating mode manager 300 is directly or indirectly connected to a radio communications module or entity 310, such as a WLAN unit, having access to information received by a wireless connection. In particular, an interface is provided for providing the operating mode change command from the radio communications entity 310 to the operating mode manager 300.

The operating mode manager 300 is further directly or indirectly connected to one or more UI output modules, entities, or units 320. For example, the manager 300 may be connected to an application or unit controlling audio output via one or more audio output devices, or directly control audio output circuitry.

An apparatus comprising at least the operating mode manager 300 may be arranged to implement at least some operating mode control related functions illustrated in further detail below. In some embodiments, the manager 300 is arranged to cause 210 the change of the operating mode in response to the received operating mode command. The manager 310 may thus change the profile currently applied by an operating system of the mobile device, for example.

Although the apparatus and the manager 300 are depicted as a single entity, different modules and memory may be implemented in one or more physical or logical entities. For instance, the manager 300 could comprise a specific functional module for carrying one or more of the steps in FIG. 2. It should be appreciated that the apparatus may comprise other units, not discussed in more detail here. The apparatus could be in a form of a chip unit or some other kind of hardware module for controlling a mobile communications device.

The apparatus may be implemented as an electronic digital computer, which may comprise memory, a processing unit or chipset with one or more processors. The apparatus may comprise also a system clock. The processing unit may be adapted to implement the controller. The processing unit may be controlled by a sequence of program instructions transferred to the processing unit from the memory.

The operating mode manager 300 may be carried out by a controller carrying out various other control features, or by a specific controller specified for operating mode management. The operating mode manager 300 may be implemented by an operating system of the mobile device, by an application program, or by special-purpose software, for example. It is to be noted that FIG. 3 is only one example of an apparatus and functional entities that may be used to carry out the present features.

Let us now further study some example embodiments related to the operating mode change related features. In one embodiment, a silent mode or profile is entered 210 on the basis of the operating mode command. Thus, audio output may be silenced during the silent mode. However, it will be appreciated that the present features may be applied to arrange mode change to any type of operating mode, e.g. a meeting profile with very low-volume beep notifications and alarms.

In some embodiments the operating modes or profiles comprise or are stored as data structures affecting operation of one or more applications. FIG. 4 illustrates examples of profiles 400, 402, 404 which may be stored in a memory of the mobile device 100. The profiles may comprise or refer to sets of settings 410. The profile data may comprise one or more of audio settings, vibration alert settings, and display settings. For example, the audio settings may be a set of parameters affecting ringing tone, ringing volume, incoming message alert, notification of available networks, scheduled alert, etc. The display settings may control display illumination, for example. The profile data 410 may comprise settings specific to a particular application or service, such as incoming voice calls, video calls, short messages, email messages, etc.

A profile change e.g. from a first profile 400 to a second profile 402 may be controlled 210 in response to the mode change command from the wireless access device. Thus, the UI output is controlled on the basis the settings of the second profile and the second profile may affect the UI output for at least one application or service. For example, the operating mode manager 300 may have access to the profiles 400-404 and change the settings, or only control the application(s) to change of the profile.

In one embodiment, the operating mode change may cause change of one or more other functions in the mobile device 100. For example, in response to the operating mode change command, a control operation regarding applications currently running or scheduling of routine activities is initiated. In a still further example, the operating mode command may cause change to low power mode or switch some or all of the radio functionality of the mobile device off or on.

FIG. 5 illustrates an algorithm which may be carried out after the operating mode change 210 by the operating mode manager 300, for example. Connectivity status related to the wireless access device, such as the AP 122, which originated the mode change command, is checked 500. The connectivity status may be checked on the basis of connection status information from the radio communications module 310, for example. The mobile device 100 may also actively scan for the access device and/or monitor the broadcast signal from the access device in connection of block 500. Thus, also non-associated mobile devices may detect the connectivity to the access device.

If on the basis of the check 500, 502 there is no connectivity, the preceding operating mode applied before the mode change may be returned. For example, when a mobile device 104 leaves the area 120 and is disconnected from the AP 122, a general profile with audible notifications may be returned.

As already indicated, the wireless access devices, such as the AP 122, may be configured to send at least one operating mode change command to mobile devices. In an example embodiment illustrated in FIG. 6, a target operating mode for mobile communication devices within a coverage area of a wireless access device is set 600. This may occur e.g. by managing settings of the access device by a configuration management program. The command(s) may be set already during manufacturing or initial commissioning of the access device. There may be two or more selectable mobile device management modes for the access device, at least one of which involves transmission of the operating mode command. The device mode management operations may be at least partly automatic. For example, the silent mode may be configured to be automatically commanded only at a scheduled time.

An operating mode change command is generated 610 for instructing change to the set target operating mode, the mode change affecting UI output of a recipient mobile device 100, 102. The mode change command is sent to at least one mobile device in the coverage area of the wireless access device. The operating mode command may then be received by the mobile device(s) and the operating mode may be changed by applying at least some of the above illustrated features.

It is to be appreciated that the above features illustrate only some examples of procedures for arranging operating mode change by external signal, and that various modifications and additions may be made to the procedure illustrated in FIGS. 2, 4, and 5.

An example variation is that there may be one or more preconditions before changing 210 the operating mode. In one example embodiment, user confirmation is requested and required before changing 210 the operating mode. According to another embodiment, signal strength of the access device is monitored. If the signal strength does not exceed a threshold, the operating mode change is prevented.

The mobile device 100 may be preconfigured, e.g. by a device manufacturer, an operator, or company IT personnel, to detect 200 one or more operating mode change commands. The access device and the mobile device may be arranged to include and detect the command(s) in an already existing or new field of a message, or a new message, from a wireless access device. The mode change command(s) may be standardized, in which case it is possible to avoid configuration to enable detection of the mode change command during use or commissioning of the mobile device.

According to some embodiments, the operating mode change command is provided in a broadcast message. Thus, each of mobile devices capable of receiving a signal with such broadcast message may receive the operating mode command and change their operating mode. Some further example embodiments are provided below with reference to IEEE 802.11 based WLANs. However, it will be appreciated that the present mode change related features may be applied with other types of wireless access networks and protocols. For example, the mode change command could be transmitted via a Bluetooth, wireless universal serial bus (WUSB), or other type of local link, or even via a cellular connection.

According to some embodiments, the operating mode command may be arranged to be carried in a beacon message, a measurement pilot message, a probe response message, and/or an association establishment related message from a WLAN AP.

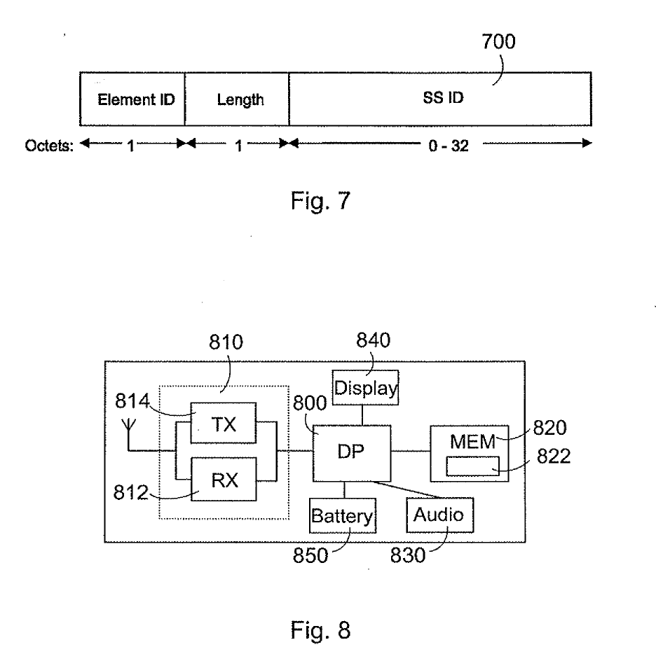

According to an embodiment, the operating mode command is included in an identifier field indicating a network, a device or a service, for example. In a further embodiment, the operating mode command is included in a service set identifier (SSID) field. The SSID element from an IEEE 802.11 WLAN AP may indicate the identity of a basic service set (BSS), an extended service set (ESS) or an independent basic service set (IBSS). FIG. 7 illustrates the IEEE 802.11 service set identifier field. The operating mode change command may be included in the SS ID sub-field 700. In one further example embodiment, the WLAN AP 122 may be configured with at least two different selectable SSIDs, one comprising the operating mode change command and the other being a conventional SSID not causing a mode change in the mobile device.

In another example embodiment, the operating mode change command is included in a new field or field reserved for vendor-specific information. It is to be noted that the operating mode command may be independent of the wireless access device. The operating mode command may be common for a plurality of wireless access devices.

According to an example embodiment, the operating mode change command comprises or is provided as a character string indicating a target operating mode. The mobile communications device switches to an operating mode associated with the character string in the operating mode change command. For example, the SSID field may comprise characters “silent”. In one further example, the SSID could simply specify “MyOffice” in case no operating mode command is included, and with operating mode command the SSID could be “MyOffice silent”.

In another embodiment the operating mode command is in a form of a command, for example “Change_Profile” with zero or more parameters specifying the target profile, e.g. by keyword “Meeting”. It will be appreciated that it is possible to apply various commonly agreed codes or other non-plain character strings to represent the operating mode change command. For example, “Prof0” could be associated with the silent profile. However, it will be understood that the above messages, fields, and formats represent only some examples, and the operating mode command may be included in various other messages, fields and formats.

FIG. 8 is a simplified block diagram of high-level elements of a mobile communications device according to an embodiment. The mobile communications device may comprise the entities of FIG. 3. The device may be configured to function as the mobile device 100, and carry out at least some of the functions illustrated above for the mobile device 100.

In general, the various embodiments of the device can include, but are not limited to, cellular telephones, personal digital assistants (PDAs), laptop/tablet computers, digital book readers, imaging devices, gaming devices, media storage and playback appliances, Internet access appliances, as well as other portable units or terminals that incorporate wireless communications functions.

The device comprises a data processing element DP 800 with at least one data processor and a memory 820 storing a program 822. The memory 820 may be implemented using any data storage technology appropriate for the technical implementation context of the respective entity. By way of example, the memory 820 may include non-volatile portion, such as EEPROM, flash memory or the like, and a volatile portion, such as a random access memory (RAM) including a cache area for temporary storage of data. The DP 800 can be implemented on a single-chip, multiple chips or multiple electrical components. The DP 800 may be of any type appropriate to the local technical environment, and may include one or more of general purpose computers, special purpose computers (such as an application-specific integrated circuit (ASIC) or a field programmable gate array FPGA), digital signal processors (DSPs) and processors based on a multi-processor architecture, for instance.

The device may comprise at least one radio frequency transceiver 810 with a transmitter 814 and a receiver 812. However, it will be appreciated that in many cases a mobile communications device is a multimode device. By way of illustration, the electronic device may comprise radio units 810 to operate in accordance with any of a number of second, third and/or fourth-generation communication protocols or the like. For example, the device may operate in accordance with wireline protocols, such as Ethernet and digital subscriber line (DSL), with second-generation (2G) wireless communication protocols, such as GSM, with third-generation (3G) wireless communication protocols, such as 3G protocols by the 3GPP, CDMA2000, WCDMA and time division-synchronous CDMA (TD-SCDMA), with fourth-generation (4G) wireless communication protocols, such as the 3GPP LTE, wireless local area networking protocols, such as the IEEE 802.11, short-range wireless protocols, such as Bluetooth, and/or the like.

The DP 800 may be arranged to receive input from UI input elements, such as an audio input circuit connected to a microphone and a touch screen input unit, and control UI output, such as audio circuitry 830 connected to a speaker and a display 840 of a touch-screen display, according to the applied operating mode. The device also comprises a battery 850, and may also comprise other UI output related units, such as a vibration motor for producing vibration alert.

It will be appreciated that the device typically comprises various further elements, such as further processor(s), further communication unit(s), user interface components, a media capturing element, a positioning system receiver, sensors, such as an accelerometer, and a user identity module, not discussed in detail herein. The device may comprise chipsets to implement at least some of the high-level units illustrated in FIG. 8. For example, the device may comprise a power amplification chip for signal amplification, a baseband chip, and possibly further chips, which may be coupled to one or more (master) data processors (800).

Embodiments of the present invention, in the mobile device and/or the wireless access device, may thus be implemented in software, hardware, application logic or a combination of software, hardware and application logic. In an example embodiment, the application logic, software or an instruction set is maintained on any one of various conventional computer-readable media.

An embodiment provides a computer program embodied on a computer-readable storage medium. The program, such as the program 822 in the memory 820, may comprise computer program code configured to, with the at least one processor, cause the device to perform at least some of the above-illustrated operating mode change related features illustrated in connection with FIGS. 2 to 7. In the context of this document, a “computer-readable medium” may be any media or means that can contain, store, communicate, propagate or transport the instructions for use by or in connection with an instruction execution system, apparatus, or device, such as a computer, with some examples of a computer being described and depicted in connection with FIGS. 3 and 8. A computer-readable medium may comprise a tangible and non-transitory computer-readable storage medium that may be any media or means that can contain or store the instructions for use by or in connection with an instruction execution system, apparatus, or device, such as a computer.

In one further example embodiment, the program may be preconfigured with information on at least one operating mode command and control the operating mode change in response to detecting such command being received in the mobile device 100. This computer program may be downloaded to the mobile device via a communication network. For example, the computer program may be stored in a memory connected to the network server 152, and loaded to the mobile device 100 over the Internet.

In one example embodiment, there may be provided circuitry or user interface circuitry configured to provide at least some operating mode control related functions illustrated above. As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware.

Although the specification refers to “an”, “one”, or “some” embodiment(s) in several locations, this does not necessarily mean that each such reference is to the same embodiment(s), or that the feature only applies to a single embodiment. Single features of different embodiments may also be combined to provide other embodiments. If desired, at least some of the different functions discussed herein may be performed in a different order and/or concurrently with each other. Furthermore, if desired, one or more of the above-described functions may be optional.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method, comprising:
detecting an operating mode change command received by a mobile communications device in a message from a wireless access device, and
changing an operating mode of the mobile communications device in response to the operating mode change command, the operating mode change affecting user interface output of the mobile communications device.

2. The method of claim 1, wherein a silent mode or profile is entered on the basis of the operating mode change command.

3. The method of claim 1, wherein the operating mode change command is in an identifier element of the message.

4. The method of claim 3, wherein the identifier element is a service set identifier element indicating identity of a service set.

5. The method of claim 1, wherein the operating mode change command is received in a broadcast message.

6. The method of claim 1, wherein the message is at least one of a beacon, a measurement pilot, a probe response message, and an association establishment related message from a wireless local area network access point.

7. The method of claim 1, wherein the operating mode change command comprises a character string indicating a target operating mode, and
the mobile communications device switches to an operating mode associated with the character string in the operating mode change command.

8. The method of claim 1, wherein the operating mode comprises one or more of audio settings, vibration alert settings, and display settings.

9. The method of claim 1, further comprising:
checking connectivity status for the wireless access device, and
in response to detecting no connectivity to the wireless access device, automatically changing to an operating mode applied before receiving the operating mode command.

10. A method, comprising:
setting a target operating mode for mobile communication devices within a coverage area of a wireless access device,
generating an operating mode change command for instructing operating mode change to the set target operating mode, the mode change affecting user interface output of a recipient mobile communications device, and
transmitting the operating mode change command to at least one mobile communications device in the coverage area of the wireless access device.

11. An apparatus, comprising:
at least one processor; and
at least one memory including computer program code,
the at least one memory and the computer program code configured to, with the at least one processor, cause the apparatus at least to:
detect an operating mode change command received in a message from a wireless access device, and
control change of an operating mode in response to the operating mode change command, the operating mode change affecting user interface output.

12. The apparatus of claim 11, wherein the apparatus is configured to enter a silent mode or profile on the basis of the operating mode change command.

13. The apparatus of claim 11, wherein the operating mode change command is in an identifier element of the message.

14. The apparatus of claim 13, wherein the identifier element is a service set identifier element indicating identity of a service set.

15. The apparatus of claim 11, wherein the apparatus is configured to receive the operating mode change command in a broadcast message.

16. The apparatus of claim 11, wherein the message is at least one of a beacon, a measurement pilot, a probe response message, and an association establishment related message from a wireless local area network access point.

17. The apparatus of claim 11, wherein the operating mode change command comprises a character string indicating a target operating mode, and the apparatus is configured to switch to an operating mode associated with the character string in the operating mode change command.

18. The apparatus of claim 11, wherein the operating mode comprises one or more of audio settings, vibration alert settings, and display settings.

19. The apparatus of claim 11, wherein the apparatus is configured to check connectivity status for the wireless access device, and
in response to detecting no connectivity to the wireless access device, the apparatus is configured to automatically change to an operating mode applied before receiving the operating mode command.

20. The apparatus of claim 11, wherein the apparatus is at least one of a chipset for a mobile communications device and a mobile communications terminal device comprising a transceiver for communicating according to an IEEE 802.11 standard.

21. An apparatus, comprising:
at least one processor; and
at least one memory including computer program code,
the at least one memory and the computer program code configured to, with the at least one processor, cause the apparatus at least to:
set a target operating mode for mobile communication devices within a coverage area of a wireless access device,
generate an operating mode change command for instructing operating mode change to the set target operating mode, the mode change affecting user interface output of a recipient mobile communications device, and
send the operating mode change command to at least one mobile communications device in the coverage area of the wireless access device.

22. An apparatus according to claim 21, wherein the apparatus is a wireless local area network access point serving as the wireless access device.
